(19) United States
(12) Patent Application Publication
(10) Pub. No.: US 2026/0356754 A1
(43) Pub. Date: Nov. 12, 2026

(54) TREATMENT OF CONCRETE AGGREGATE WITH A WATER-REPELLANT SOLUTION

(71) Applicants: E. Michael Consalvi, Sparks, NV (US); Todd Cooklin, Las Vegas, NV (US)

(72) Inventors: E. Michael Consalvi, Sparks, NV (US); Todd Cooklin, Las Vegas, NV (US)

(21) Appl. No.: 19/201,744

(22) Filed: May 7, 2025

(51) Int. Cl. C04B 20/10; C04B 20/04; C04B 103/65; C04B 111/27

(52) U.S. Cl. CPC C04B 20/10; C04B 20/04; C04B 2103/65; C04B 2111/27

(57) ABSTRACT

The method may comprise pre-processing aggregate, drying the aggregate, applying water-repellent solution to the aggregate to create treated aggregate, drying the treated aggregate, conducting a specific gravity test of a trial batch of the treated aggregate, and mixing the treated aggregate with cement and water to create concrete.

### TECHNICAL FIELD

This disclosure generally relates to improvements to concrete, and more particularly, to treating concrete aggregate with a water-repellant solution.

### BACKGROUND

Concrete is created by mixing cement, water and aggregate. Concrete aggregates include granular (geological) materials such as sand, gravel, crushed rock or recycled concrete. The concrete aggregate typically provides the filler, durability and strength of the concrete mix. The size, shape and type of aggregate used in concrete should be chosen based on the specific requirements of the project, such as the desired strength, durability, appearance and costs. For example, larger aggregates can reduce the amount of cement needed, which may lower the cost of the concrete mix.

However, quality aggregate is often scarce, and imperfect aggregate may be porous. The porous aggregate may cause problems because moisture may seep into the aggregate and the moisture may be present on the surface of the aggregate. The aggregate may be air dried to remove the moisture on the surface, but some internal pores may still retain the moisture. The excess moisture in and on the aggregate may cause problems with the concrete creation process because the extra moisture may alter the overall water-cement ratio. Too much water weakens the concrete, while not enough can hinder proper cement hydration. The water-cement ratio is often critical to achieve the desired concrete properties of strength and durability. Excessive moisture in concrete floors can lead to adhesive failure, discoloration and other issues. Furthermore, when aggregate with moisture goes through a freeze cycle, the aggregate may pop out of the concrete. Moreover, when the high acidity of the cement paste mixes with moisture in the aggregate, an unwanted chemical reaction may occur which further damages the concrete. Some have tried to remove the cement paste from the recycled concrete, but the cement paste is typically not able to be fully removed from the recycled concrete, while the removal is often expensive and time-consuming.

### SUMMARY

In various embodiments, the method may comprise pre-processing aggregate, drying the aggregate, applying water-repellent solution to the aggregate to create treated aggregate, drying the treated aggregate, conducting a specific gravity test of a trial batch of the treated aggregate, and mixing the treated aggregate with cement and water to create concrete.

In various embodiments, the water-repellent solution may minimize or restrict water absorption. The water-repellent solution may include a catalyzed water-repellent solution that enhances penetration into the aggregate. The pre-processing the aggregate may include one or more of crushing, screening, washing or drying operations. The applying the water-repellent solution to the aggregate may occur when the surface temperature of the aggregate is about 50 degrees F or greater. The applying the water-repellent solution to the aggregate may occur when the surface temperature of the aggregate is above 40 degrees F for about 8 hours. The applying the water-repellent solution to the aggregate may occur when the surface temperature of the aggregate is lower than about 90 degrees F for about 8 hours. The applying the water-repellent solution may occur while the aggregate is tumbled or moved. A dosage rate of the applying the water-repellent solution may be based on a moisture absorption rate of the aggregate.

In various embodiments, the drying of the treated aggregate may include stockpiling the treated aggregate or tumbling the treated aggregate in a dryer. The conducting a specific gravity test of a trial batch of the treated aggregate may use the formula: (Oven-Dry Weight)/((SSD Weight)-(Weight in Water)). The conducting a specific gravity test of a trial batch of the treated aggregate may include re-testing for an absorption rate to determine that the water-repellent solution is keeping moisture out of the treated aggregate. The conducting a specific gravity test of a trial batch of the treated aggregate may include durability testing of the treated aggregate to confirm that the treated aggregate is still sufficiently durable.

### BRIEF DESCRIPTION OF THE DRAWINGS

The accompanying drawings, wherein like numerals depict like elements, illustrate exemplary embodiments of the present disclosure, and together with the description, serve to explain the principles of the disclosure. In the drawings:

FIG. 1 is a flowchart showing an exemplary process for treating concrete aggregate with a water-repellant solution, in accordance with various embodiments.

### DETAILED DESCRIPTION

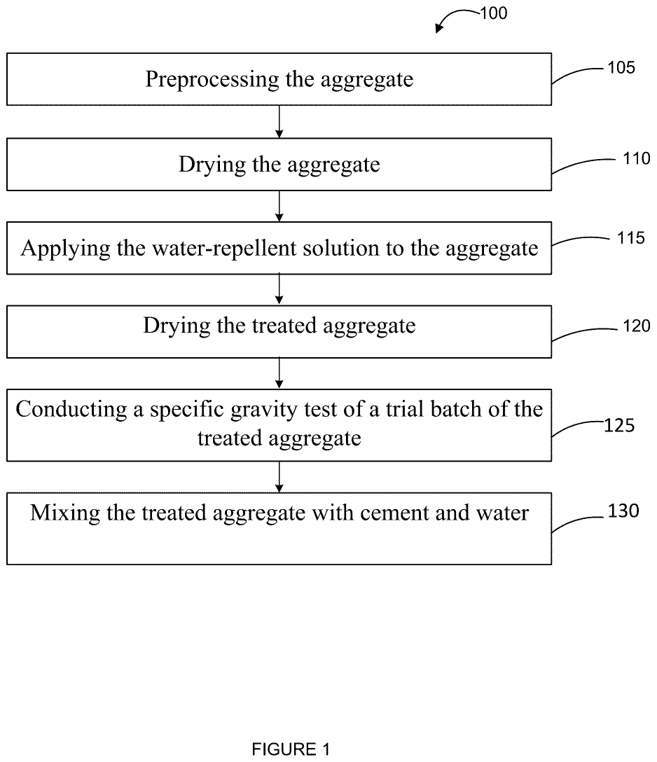

In various embodiments, with respect to FIG. 1, the method 100 involves treating concrete aggregates with a water-repellent solution. The water-repellent solution may include any solution that minimizes or restricts water absorption. The process for applying the water-repellent solution provides enhanced penetration into pores of the aggregates. In various embodiments, the water-repellent solution may be a catalyzed water-repellent solution, wherein the catalyst enhances the penetration. In particular, the catalyst assists the carrier fluid to provide better penetration.

The concrete aggregate may be pre-processed (step 105), prior to mixing the aggregate with cement and water to create the concrete mixture. In various embodiments, pre-processing the aggregate may include one or more of crushing, screening, washing and/or drying operations. The method may include applying the water-repellent solution, after those pre-processing steps, but before mixing the aggregate with cement and water to create the concrete mixture. Applying the water-repellent solution after those pre-processing steps is beneficial because the water-repellent solution may coat at least a portion of the outside of aggregate. In particular, after the aggregate is crushed, the inside surfaces of the aggregate may be exposed. However, if the water-repellent solution was only applied to the outside surface of the aggregate, the newly exposed inside surfaces may not have any water-repellent solution on the inside surfaces. If the water-repellent solution is applied after the crushing, then both the outside and newly exposed inside surfaces can all be coated with the water-repellent solution. Moreover, the crushing process may cause dust and particles. If the water-repellent solution is applied before the crushing process, then such dust and particles may get trapped in the water-repellent solution, which may reduce the effectiveness of the water-repellent solution. In various embodiments, a specific gravity test for absorption may be performed on the preprocessed aggregate, before being treated. The process may compare the absorption before treatment and the absorption after treatment.

In various embodiments, the method may include drying the aggregate (step 110) before applying the water-repellent solution. The aggregate should optimally have no moisture before applying the water-repellent solution. However, the goal is minimal moisture because reduced moisture allows for more effective applying of the water-repellent solution. Lightweight aggregates may be subjected to additional drying due to containing more moisture and/or being more porous. Dense aggregates may only be subjected to minimal drying due to containing less moisture and/or being less porous.

After the pre-processing and the drying of the aggregate, the method may include applying the water-repellent solution to the aggregate (step 115). For improved results, the water-repellent solution should be applied to the aggregate at certain temperature ranges. For example, the water-repellent solution should be applied to the aggregate when the surface temperature of the aggregate is about 50 degrees F or greater. The surface temperature of the aggregate should also not drop below 40 degrees F for the next about 8 hours or be higher than about 90 degrees F for the next about 8 hours. The temperature ranges are important because freezing temperatures may stop the reaction and lower temperatures may slow down the process. Moreover, during high temperatures, the water-repellent solution may dry too quickly. If the water-repellent solution dries too quickly, then the water-repellent solution may not have time to sufficiently penetrate the aggregate.

The aggregate may be treated by spraying the water-repellent solution onto the aggregate. To help increase the coverage of the water-repellent solution, in various embodiments, the aggregate may be applied with a light spray of the water-repellent solution, as the aggregate is tumbled or moved. In various embodiments, the aggregate may be intermittently tumbled as the spray of the water-repellent solution is applied to the aggregate. The dosage rate of the water-repellent solution may be based on the moisture absorption rate of the aggregate. The moisture absorption rate of the aggregate may be determined by the aggregate trial batch information. The dosage rate may be adjusted based on the amount of fluid excreted by the sprayer, the pressure of the spray, the number of nozzles in the sprayer, etc.

As mentioned, the water-repellent solution may include a catalyst that allows the solution to penetrate into the aggregate. The water-repellent solution penetrating into the aggregate is beneficial to minimize the aggregate from removing the moisture from the cement paste. When the cement paste has sufficient or optimal moisture, then the cement paste is better able to bond with the aggregate.

After treating the aggregate with the water-repellent solution, the method may include drying the treated aggregate (step 120). The optimal method is to wait until the aggregate is completely dry. By drying the aggregate, the water-repellent solution is given time to adhere to the aggregate. If the water-repellent solution is sufficiently adhered to the aggregate, then at least some or all of the water-repellent solution is prevented from being wiped off of the aggregate surface and/or adhering to other surfaces. The drying of the treated aggregate may include stockpiling the aggregate or tumbling the treated aggregate in a dryer (e.g., asphalt dryer). The dryer may be set to about 70-80 degrees F. The treated aggregate may also be determined to be sufficiently dry based on visual inspection.

The amount of water the aggregate can absorb is influenced by its porosity, the type of material, and the conditions of exposure. Longer exposure to water may generally lead to greater absorption. Higher temperatures can also influence the rate of water absorption. The moisture absorption rate of the aggregate may be determined by a specific gravity test of the aggregate (step 125). The specific gravity test for the aggregate determines the ratio of the weight of the aggregate to the weight of an equal volume of water. This test helps to determine the density, quality and strength of the aggregate. Aggregates with higher specific gravity values generally indicate greater strength and better quality. Specific gravity helps in determining the percentage of voids in the mix, which can also affect the strength and durability of the structure. Specific gravity values also help in monitoring the quality and consistency of aggregate materials used in construction. The test helps to determine the weight-to-volume relationships of aggregates. The test typically involves weighing the aggregate in three conditions: oven-dry, saturated surface-dry (SSD), and submerged in water. The oven-dry weight is the weight of the aggregate after being heated in an oven to remove all moisture. The SSD weight is the weight of the aggregate after being fully saturated with water and then dried on the surface. The weight in water is the weight of the aggregate when submerged in water. The specific gravity is calculated using the formula: (Oven-Dry Weight)/((SSD Weight)-(Weight in Water)). Water absorption capacity for coarse aggregates is typically between 0.5 and 1% by weight. The maximum limit is generally considered to be 2%. Fine aggregates can have a higher water absorption range, typically between 0.3 and 2.5%, with a maximum permissible limit of 3%. This can vary depending on whether the sand is crushed or natural. The water absorption of aggregates used in road construction ranges from 0.1 to 2.0%.

Before using the batch of aggregate for production, the method may include conducting a specific gravity test on a trial batch of aggregate which may result in a water absorption capacity of 1%. The trial batch may be re-tested for the absorption rate to determine that the water-repellent solution is keeping the moisture out of the treated aggregate. The method may also include durability testing of the treated aggregate to confirm that the treated aggregate is still sufficiently durable because some aggregates may get soft after the aggregate is wet for a longer period of time. If the trial batch of treated aggregate has a sufficient water absorption capacity, the method may include mixing the treated aggregate with the cement and water to create the concrete (step 130). The concrete mixture may be tested for strength and durability.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for purposes of limitation.

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process and may include values that are within 5% of a stated value. Additionally, the terms “substantially,” “about” or “approximately” as used herein represent an amount close to the stated amount that still performs a desired function or achieves a desired result. For example, “substantially”, “approximately” or “about” can, in some embodiments, mean within plus or minus ten percent of the stated value. In other embodiments, “substantially”, “approximately” or “about” can mean within plus or minus five percent of the stated value. In further embodiments, “approximately” or “about” can mean within plus or minus three percent of the stated value. In yet other embodiments, “substantially”, “approximately” or “about” can mean within plus or minus one percent of the stated value. Further, all ranges may include upper and lower values and all ranges and ratio limits disclosed herein may be combined.

Although system and methods have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of the figures may be modified, and that the foregoing discussion of certain of these embodiments does not necessarily represent a complete description of all possible embodiments. For example, one or more of the procedures, processes, or activities may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

The steps recited in any of the method or process descriptions may be executed in any order and are not limited to the order presented. Moreover, any of the functions or steps may be outsourced to or performed by one or more third parties. Modifications, additions, or omissions may be made to the system, apparatuses, and methods described herein without departing from the scope of the disclosure. For example, the components of the system and apparatuses may be integrated or separated. An individual component may be comprised of two or more smaller components that may provide a similar functionality as the individual component. Moreover, the operations of the system and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise, as set forth in Slip op. at 8-9 (Fed. Cir. Oct. 19, 2023) (citing Baldwin Graphic Sys., Inc. v. Siebert, Inc., 512F.3 d1338, 1342-43 (Fed. Cir. 2008)).

System, methods, and products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Although the invention has been shown and described with respect to several preferred embodiments, certain equivalent alterations and modifications may occur to others skilled in the art upon the reading and understanding of these specifications and the concepts illustrated in the annexed drawings. In particular with regard to the various functions performed by the above described components (assemblies, devices, etc.) and the terms used to describe such components and their functions, these are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention.

In addition, while a particular feature of the invention may have been disclosed with respect to only one of the several embodiments, such feature may be combined with one or more features of the other embodiments as may be desired and advantageous for any given or particular application, and any embodiments later deemed unnecessary or undesirable may be excluded without consequence to the validity of the other claims. This applies to all the claims and specifically to the system and various designs of the system and its function holding in place any one upper surface, while resting on any other lower surface and simultaneously allowing for rotation.

1. A method comprising:
pre-processing aggregate;
drying the aggregate;
conducting a specific gravity test of a trial batch of the aggregate;
applying water-repellent solution to the aggregate to create treated aggregate;
drying the treated aggregate;
conducting a specific gravity test of a trial batch of the treated aggregate; and
mixing the treated aggregate with cement and water to create concrete.

2. The method of claim 1, wherein the water-repellent solution minimizes or restricts water absorption.

3. The method of claim 1, wherein the water-repellent solution includes a catalyzed water-repellent solution that enhances penetration into the aggregate.

4. The method of claim 1, wherein the pre-processing the aggregate includes one or more of crushing, screening, washing or drying operations.

5. The method of claim 1, wherein the applying the water-repellent solution to the aggregate occurs when the surface temperature of the aggregate is about 50 degrees F or greater.

6. The method of claim 1, wherein the applying the water-repellent solution to the aggregate occurs when the surface temperature of the aggregate is above 40 degrees F for about 8 hours.

7. The method of claim 1, wherein the applying the water-repellent solution to the aggregate occurs when the surface temperature of the aggregate is lower than about 90 degrees F for about 8 hours.

8. The method of claim 1, wherein the applying the water-repellent solution is while the aggregate is tumbled or moved.

9. The method of claim 1, wherein a dosage rate of the applying the water-repellent solution is based on a moisture absorption rate of the aggregate.

10. The method of claim 1, wherein the drying of the treated aggregate includes stockpiling the treated aggregate or tumbling the treated aggregate in a dryer.

11. The method of claim 1, wherein the conducting a specific gravity test of a trial batch of the treated aggregate uses the formula: (Oven-Dry Weight)/((SSD Weight)-(Weight in Water)).

12. The method of claim 1, wherein the conducting a specific gravity test of a trial batch of the treated aggregate includes re-testing for an absorption rate to determine that the water-repellent solution is keeping moisture out of the treated aggregate.

13. The method of claim 1, wherein the conducting a specific gravity test of a trial batch of the treated aggregate includes durability testing and strength testing of the treated aggregate to confirm that the treated aggregate is still sufficiently durable and strong.
